(19) United States
(12) Patent Application Publication
(10) Pub. No.: US 2016/0125855 A1
(43) Pub. Date: May 5, 2016

(54) Drum Cover

(71) Applicant: Paul Broughton, Exmouth, Devon (GB)

(72) Inventor: Paul Broughton, Exmouth, Devon (GB)

(21) Appl. No.: 14/894,866

(22) PCT Filed: May 29, 2014
(86) PCT No.: PCT/EP2014/061199

§ 371 Date: Nov. 30, 2015

(30) Foreign Application Priority Data
May 29, 2013 (GB) 1309571.6

(51) Int. Cl. G10D 13/02

(52) U.S. Cl. CPC G10D 13/022

(57) ABSTRACT

A cover for a bass drum. The cover has a disc-shaped main body. A surface of the main body has a layer of sound proofing material. The cover is attachable in a detachable manner to a rim of the drum so as to extend across the surface of the drum skin.

### FIELD OF INVENTION

The present invention relates to a drum cover. More especially the invention relates to a drum cover developed to fit onto a bass drum and which includes sound proofing means and a surface on which a band's name and/or logo can be displayed.

### BACKGROUND TO THE INVENTION

It is common to hold musical events that include a number of bands following one another on a single stage. The procedure of changing between bands, in front of an audience, is one that requires speed and efficiency. As such, there is little time, if any at all, for the band following to show off, and in some cases even identify, their band name. A common location for displaying a band name is on the front surface of the drum skin of the base drum of a drum kit, facing the audience. However, in multi-band events, drums kits are often shared and such displays are not possible.

The present invention seeks to alleviate this problem by providing a cover for a bass drum that is easy to fit and remove and which provides extra sound qualities to the bass drum on which it is fitted.

### STATEMENT OF INVENTION

According to a first aspect of the invention there is provided a cover for a drum, the cover comprising a disc-shaped main body, a surface of the main body having formed or located thereon a layer of sound proofing material, the cover having means to attach in a detachable manner, the cover to a rim of the drum such that the cover extends across the surface of the drum skin.

Preferably the sound proofing material comprises a foam layer.

Preferably the foam is segmented. Preferably the sound proofing layer comprises at least two separate segments of foam material. Preferably still the sound proofing layer comprises four separate segments of foam material.

Preferably one side of the main body has etched lines to provide location means for locating the sound proofing material on the main body.

Preferably, when fitted, the foam layer faces inwardly towards the drum skin without touching the skin.

Preferably the attachment means comprises at least two spring-loaded brackets attached to opposing sides of a surface of the cover.

Preferably the tension rod extends between the spring-loaded brackets diametrically across the surface.

Preferably the spring-loaded brackets are fixed on a surface of the cover and, in use, are overlaid by the foam layer.

Preferably the tension rod is received within a groove formed in a surface of the foam layer.

Preferably the attachment means additionally comprises at least one retainer bracket one end of which secures to the rim of a drum in use.

### BRIEF DESCRIPTION OF THE DRAWINGS

One embodiment of the invention will now be described by way of example only, with reference to the accompanying figures in which:

FIG. 1 is a view of a front side of a drum cover constructed in accordance with the invention;

FIG. 2 is a view of the main body of a drum cover;

FIG. 3 is an exploded view of the drum cover of FIGS. 1 and 2;

FIG. 4 is an exploded view of a spring-loaded bracket of FIG. 3; and

FIG. 5 shows the drum cover attached, in use, to a bass drum.

### DETAILED DESCRIPTION OF PREFERRED EMBODIMENTS

As can be seen in the figures the invention is directed to a cover 2 for, in the case described a bass drum 4. The cover 2 comprises a generally circular or disc-shaped body made from acrylic or similar material in sheet form. The main body 6 is preferably around 3 mm thick.

One surface 8 of the main body 6 is capable of receiving a layer of sound-dampening (uncompressed) foam 10. The foam layer 10 is around 10 mm to 20 mm thick, preferably 15 mm thick.

The foam 10 is formed as four separate segments 10A-D which provide a generally circular shape when placed side-by-side.

As can be seen from FIG. 2, the surface 8 of the main body 6 has etched lines 12 to provide location means for the segments of foam 10. Once located correctly, the foam segments 10 are adhered to the surface 8 using a suitable adhesive.

In use, when the cover 2 is fixed to the bass drum 4, the foam layer 10 faces the drum skin. The foam does not however touch the skin.

The circular cover 2 is approximately 520 mm to fit (with fixings) an internal diameter of a drum rim of around 565 mm.

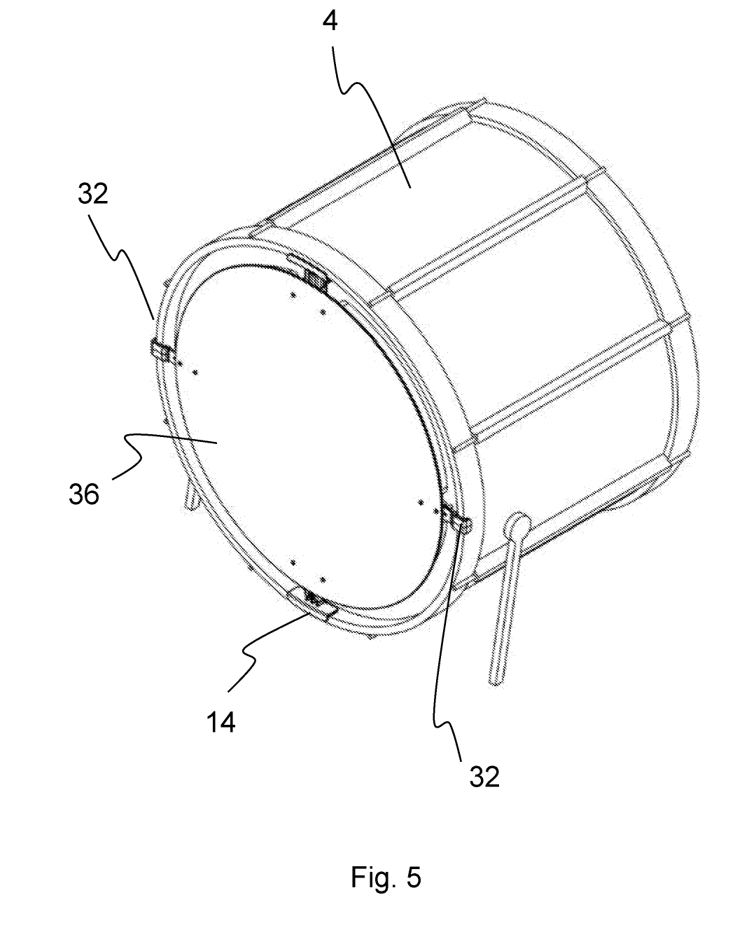

As can be seen best in FIG. 5, the cover 2 is, in use, fixed to the front of a bass drum 4 (“front” meaning the surface facing the audience and away from the drummer).

The cover 2 is secured in place between the front rim of the drum 4 using spring-loaded brackets 14 attached to either end of an aluminium runner 16 which extends across the entire diameter of the surface 8 of the body 6. The runner 16 acts as a tension rod across the drum cover 2.

Each end of the runner 16 extends into a housing 18 formed on a respective spring loaded bracket 14. The spring-loaded bracket 14 includes a foot portion 20. The end surface of the foot portion 20 includes a lip 22 and an engagement surface 24, which abuts the rim of the bass drum 4 in use and includes a strip 26 made of rubber or similar material which pushes outwardly against the rim of the bass drum 4 due to the bias of springs 28 within the bracket 14. The runner 16 may be telescopic. The runner 16 sits, in use, in a gap 30 provided between neighbouring foam segments 10 such that the runner 16 sits against the main body 6 and does not extend beyond the depth of the foam 10.

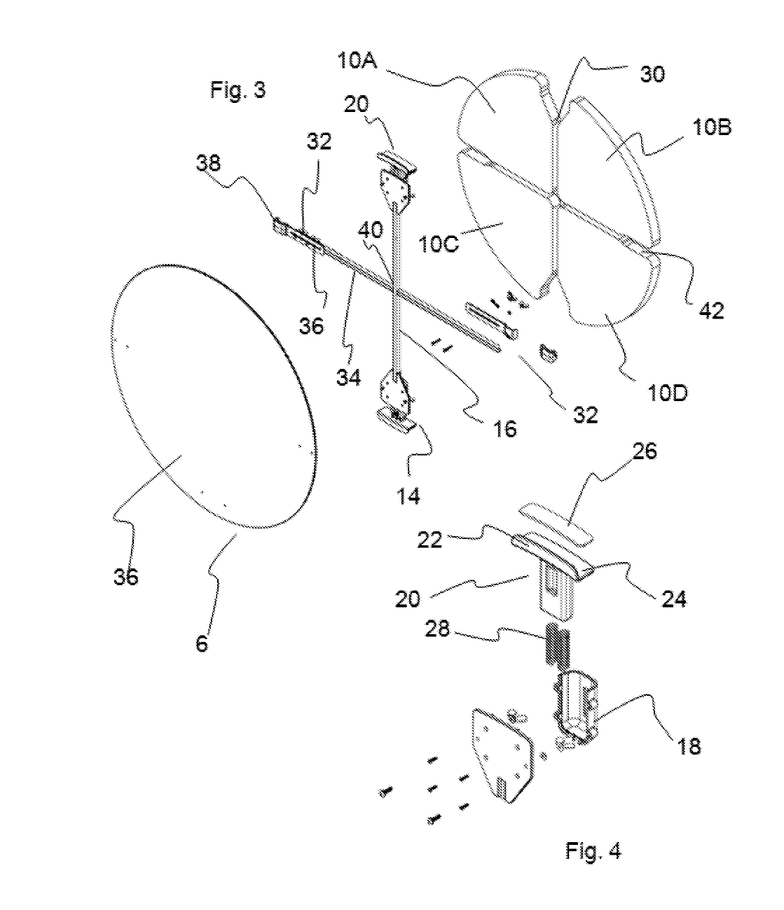

Two retainer brackets 32 are located at opposite sides of the body 6 are also located on the perimeter of the body 6. As can be seen in FIG. 3, each retainer bracket 32 has a connecting arm 34, made form aluminium or similar material with an elongate recess 36 to receive screws to allow the bracket 32 to be adjustable.

The end of each arm 28 includes a L-shaped plastic or rubber grip 38 which, in use, secures to the rim of the bass drum 4 (see FIG. 5).

The centre of the runner 16 has a slot 40 through which the connecting arm 34 can extend such that the runner 16 and connecting arm are linked together in a cross formation.

The connecting arm 34 also sits, in use, in a gap 42 provided between neighbouring foam segments 10 such that the arm 34 sits against the main body 6 (perpendicular to the runner 16) and does not extend beyond the depth of the foam 10.

In an alternative embodiment (not shown) the foam is provided a single piece and includes perpendicular grooves along and within which the runner 16 and connecting arm 34 may be located.

The external diameter (including the retainer brackets 32 and spring-loaded brackets 14) is preferably in the region of 580 to 600 mm. Preferably around 590 mm.

All the fixing members (meaning the retainer brackets 32 and spring loaded brackets 14) are located at the periphery of the main body 6 and extend from one surface 8 of the body 6 (said surface facing the drum in use) to allow for a maximum clean front surface 36 of the cover to be used to display a band name or logo.

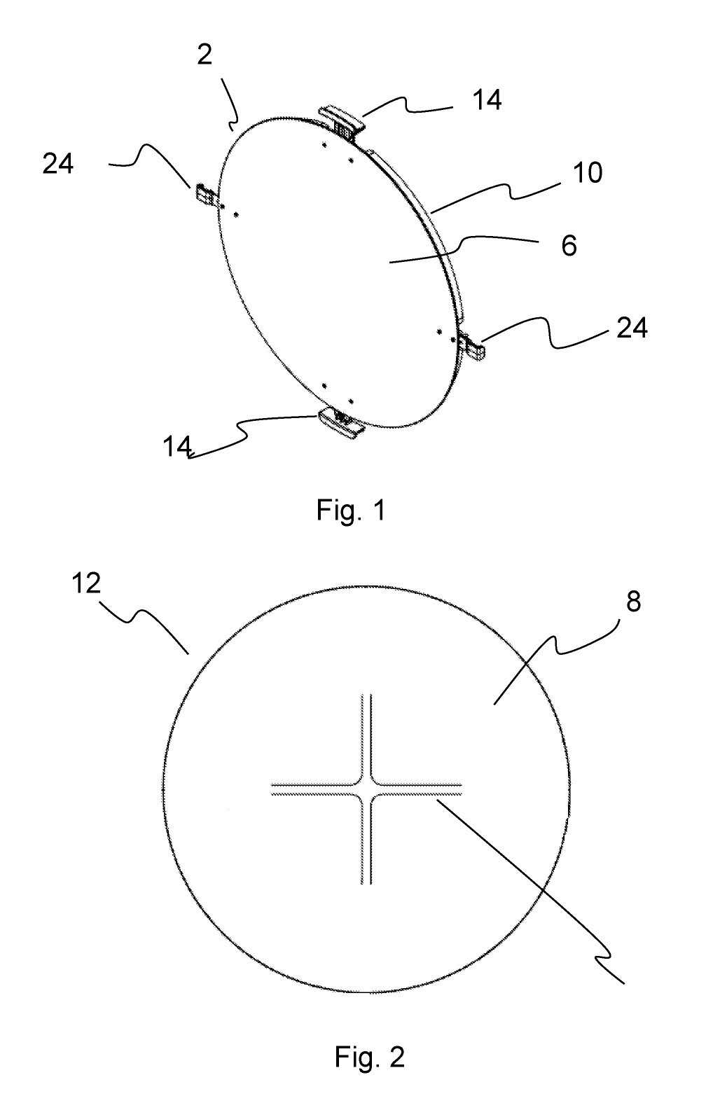

All the engagement areas of all the fixings 14, 32 are rubber backed to protect the drum rim during use. As can be seen in FIG. 1 the spring-loaded brackets 14 extend against the internal surface of the drum rim when the cover 2 is fitted. The retainer brackets 34 extend over and around the outer edge of the rim. This prevents the cover 2 being pushed too far and against the drum skin when being installed.

It will be appreciated that the foregoing are merely an examples of embodiments and just some examples of their use. The skilled reader will readily understand that modifications can be made thereto without departing from the true scope of the inventions.

1. A cover for a drum, the cover comprising:
a disc-shaped main body, a surface of the main body having formed or located thereon a layer of sound proofing material, and
means for attaching in a detachable manner, the cover to a rim of the drum so as to extend across a surface of a skin of the drum.

2. The cover according to claim 1, wherein the sound proofing material comprises a foam layer.

3. The cover according to claim 2, wherein the foam layer is segmented.

4. The cover according to claim 3, wherein the foam layer comprises four separate segments.

5. The cover according to claim 4, wherein the foam layer, when fitted, faces inwardly towards the drum skin without touching the skin.

6. The cover according to claim 1, wherein the means for attaching comprises at least two spring-loaded brackets attached to opposing sides of a surface of the cover.

7. The cover according to claim 6, wherein a tension rod extends between the spring-loaded brackets diametrically across the surface.

8. The cover according to claim 6, wherein the spring-loaded brackets are fixed to a surface of the cover and, in use, are overlaid by the foam layer.

9. The cover according to claim 7, wherein the tension rod is received within a groove formed in a surface of the foam layer.

10. The cover according to claim 1, wherein the means for attaching comprises, or additionally comprises at least one retainer bracket one end of which secures to the rim of the drum in use.

11. (canceled)

12. A cover for a drum, the cover comprising:
a disc-shaped main body, a surface of the main body having formed or located thereon a layer of sound proofing material, and
an attachment configured to attach in a detachable manner the cover to a rim of the drum so as to extend across a skin of the drum.
